(19) United States
(12) Patent Application Publication
(10) Pub. No.: US 2022/0358800 A1
(43) Pub. Date: Nov. 10, 2022

(54) DEVICE AND METHOD FOR RECORDING DRIVE VIDEO OF VEHICLE

(71) Applicants: Hyundai Motor Company, Seoul (KR); Kia Corporation, Seoul (KR)

(72) Inventor: Jeong Hun HAM, Goyang-si (KR)

(73) Assignees: Hyundai Motor Company, Seoul (KR); Kia Corporation, Seoul (KR)

(21) Appl. No.: 17/486,443

(22) Filed: Sep. 27, 2021

(30) Foreign Application Priority Data
May 10, 2021 (KR) 10-2021-0060240

(51) Int. Cl. G07C 5/08; G06K 9/00

(52) U.S. Cl. CPC G07C 5/0866; G06K 9/00825

(57) ABSTRACT

A device and a method for recording a drive video of a vehicle may include a camera configured for filming a front video, a rear video, and a rear-side video of the vehicle, and a controller that detects the dangerous situation of the vehicle based on the rear-side video filmed by the camera, and records the front video, the rear video, and the rear-side video of the vehicle filmed by the camera as an event video in storage in the detected dangerous situation.

### CROSS-REFERENCE TO RELATED APPLICATION

The present application claims priority to Korean Patent Application No. 10-2021-0060240, filed on May 10, 2021, the entire contents of which is incorporated herein for all purposes by this reference.

### BACKGROUND OF THE INVENTION

### Field of the Invention

The present invention relates to a technology of recording a drive video of a vehicle in association with a camera monitoring system (CMS) that replaces a sideview mirror of the vehicle.

### Description of Related Art

In general, a device for recording a drive video of a vehicle includes a camera that films the drive video of the vehicle, a video processor that converts the drive video filmed by the camera into a digital signal to generate digital video information, at-all-times video storage that continuously stores the digital video information generated by the video processor in real time, an impact sensor that detects an external impact and measures an amount of impact, a controller that compares the amount of impact measured by the impact sensor with a reference value to determine whether the external impact is a valid impact or an invalid impact, event video storage that stores digital video information corresponding to the valid impact, a display that displays the drive video filmed by the camera, an audio device that provides a sound corresponding to the drive video filmed by the camera, and an input device that inputs a control command to the controller.

In this connection, the at-all-times video storage continuously stores digital video information corresponding to the drive video filmed by the camera, then, when a storage space is insufficient, stores digital video information corresponding to a drive video newly filmed by the camera while sequentially deleting the oldest stored digital video information. When the amount of impact received from the impact sensor exceeds the reference value, the controller determines that a fender-bender has occurred, and stores digital video information for 15 seconds immediately before and 15 seconds immediately after a time point at which the amount of impact is received in the event video storage.

Such conventional device for recording the drive video of the vehicle is not able to provide a rear-side video only to provide a front video and a rear video of the vehicle to a user, and determines whether to store the video based on the result of the comparison between the amount of impact received from the impact sensor and the reference value, so that a normal drive video may be recorded unnecessarily when the reference value is set low, and an accident video is not recorded when the reference value is set high.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a device and a method for recording a drive video of a vehicle which may acquire a rear-side video of the vehicle in association with a camera monitoring system (CMS), detect a dangerous situation of the vehicle based on the acquired rear-side video, and record the rear-side video of the vehicle as an event video in the detected dangerous situation, providing a user with a rear-side video which may prove a fault of a rear-side vehicle caused the dangerous situation.

The technical problems to be solved by the present inventive concept are not limited to the aforementioned problems, and any other technical problems not mentioned herein will be clearly understood from the following description by those skilled in the art to which various exemplary embodiments of the present invention pertains.

According to various aspects of the present invention, a device configured for recording a drive video of a vehicle includes a camera configured for filming a front video, a rear video, and a rear-side video of the vehicle, and a controller that detects a dangerous situation of the vehicle based on the rear-side video filmed by the camera, and records the front video, the rear video, and the rear-side video of the vehicle filmed by the camera as an event video in storage in the detected dangerous situation.

In various exemplary embodiments of the present invention, the device may further include a buffer electrically connected to the controller and for temporarily storing the front video, the rear video, and the rear-side video of the vehicle filmed by the camera, and a sensor electrically connected to the controller and configured for detecting an amount of impact applied to the vehicle.

In various exemplary embodiments of the present invention, the controller may be configured to determine that the dangerous situation has occurred to the vehicle, and record, in the storage as the event video, a video before an impact time point from the front video, the rear video, and the rear-side video of the vehicle stored in the buffer when the controller determines that the amount of the impact detected by the sensor exceeds a reference value.

In various exemplary embodiments of the present invention, the controller may activate the camera and the sensor while the vehicle is being parked, and determine that the dangerous situation has occurred to the vehicle, and record, in the storage as the event video, a video before an impact time point from the front video, the rear video, and the rear-side video of the vehicle stored in the buffer when the controller determines that the amount of the impact detected by the sensor exceeds a reference value.

In various exemplary embodiments of the present invention, the controller may activate the sensor while the vehicle is being parked, and determine that the dangerous situation has occurred to the vehicle to activate the camera, and record the front video, the rear video, and the rear-side video of the vehicle filmed by the camera, in the storage as the event video when the controller determines that the amount of the impact detected by the sensor exceeds a reference value.

In various exemplary embodiments of the present invention, the controller may activate the sensor while the vehicle is being parked, and determine that the dangerous situation has occurred to the vehicle to activate the camera, and record the rear-side video of the vehicle filmed by the camera, in the storage as the event video when the controller determines that the amount of the impact detected by the sensor exceeds a reference value.

In various exemplary embodiments of the present invention, the controller may be configured to determine that the dangerous situation has occurred to the vehicle, and record the front video, the rear video, and the rear-side video of the vehicle filmed by the camera, in the storage as the event video when the controller determines that a speed of a rear-side vehicle located within a reference distance from the vehicle exceeds a speed limit of a road.

In various exemplary embodiments of the present invention, the controller may estimate the speed of the rear-side vehicle according to a speed of the vehicle and the rear-side video, and record the speed of the vehicle and the speed of the rear-side vehicle together with the event video.

In various exemplary embodiments of the present invention, the controller may be configured to determine that the dangerous situation has occurred to the vehicle, and record the front video, the rear video, and the rear-side video of the vehicle filmed by the camera, in the storage as the event video when the controller determines that a rear-side vehicle located within a reference distance from the vehicle enters a travel line of the vehicle.

In various exemplary embodiments of the present invention, the controller may be configured to determine whether the rear-side vehicle has entered the travel line of the vehicle according to the rear-side video.

In various exemplary embodiments of the present invention, the controller may be configured to determine that the dangerous situation has occurred to the vehicle, and record the front video, the rear video, and the rear-side video of the vehicle filmed by the camera, in the storage as the event video when the controller determines that a rear-side vehicle is located within a reference distance from the vehicle while a turn signal lamp of the vehicle is turned on.

In various exemplary embodiments of the present invention, the controller may detect the rear-side vehicle located within the reference distance from the vehicle according to the rear-side video.

According to various aspects of the present invention, a method for recording a drive video of a vehicle includes filming, by a camera, a front video, a rear video, and a rear-side video of the vehicle, and detecting, by a controller electrically connected to the camera, a dangerous situation of the vehicle based on the rear-side video filmed by the camera, and recording the front video, the rear video, and the rear-side video of the vehicle filmed by the camera as an event video in storage in the detected dangerous situation.

In various exemplary embodiments of the present invention, the recording of the front video, the rear video, and the rear-side video of the vehicle may include temporarily storing, by a buffer, the front video, the rear video, and the rear-side video of the vehicle filmed by the camera, detecting, by a sensor, an amount of impact applied to the vehicle, and determining, by the controller, that the dangerous situation has occurred to the vehicle, and recording, in the storage as the event video, a video before an impact time point from the front video, the rear video, and the rear-side video of the vehicle stored in the buffer when the controller determines that the amount of impact exceeds a reference value.

In various exemplary embodiments of the present invention, the recording of the front video, the rear video, and the rear-side video of the vehicle may include temporarily storing, by a buffer, the front video, the rear video, and the rear-side video of the vehicle filmed by the camera, activating, by the controller, the camera and a sensor electrically connected to the controller and configured for detecting an amount of impact applied to the vehicle while the vehicle is being parked, and determining, by the controller, that the dangerous situation has occurred to the vehicle, and recording, in the storage as the event video, a video before an impact time point from the front video, the rear video, and the rear-side video of the vehicle stored in the buffer when the controller determines that the amount of impact exceeds a reference value.

In various exemplary embodiments of the present invention, the recording of the front video, the rear video, and the rear-side video of the vehicle may include activating, by the controller, a sensor electrically connected to the controller and configured for detecting an amount of impact applied to the vehicle while the vehicle is being parked, and determining that the dangerous situation has occurred to the vehicle to activate the camera, and recording the front video, the rear video, and the rear-side video of the vehicle filmed by the camera, in the storage as the event video when the controller determines that the amount of impact exceeds a reference value.

In various exemplary embodiments of the present invention, the recording of the front video, the rear video, and the rear-side video of the vehicle may include activating, by the controller, a sensor electrically connected to the controller and configured for detecting an amount of impact applied to the vehicle while the vehicle is being parked, and determining, by the controller, that the dangerous situation has occurred to the vehicle to activate the camera, and recording the rear-side video of the vehicle filmed by the camera, in the storage as the event video when the controller determines that the amount of impact exceeds a reference value.

In various exemplary embodiments of the present invention, the recording of the front video, the rear video, and the rear-side video of the vehicle may include estimating, by the controller, a speed of a rear-side vehicle located within a reference distance from the vehicle based on the rear-side video and a speed of the vehicle, and determining, by the controller, that the dangerous situation has occurred to the vehicle, and recording the speed of the vehicle and the speed of the rear-side vehicle together with the event video when the controller determines that the speed of the rear-side vehicle exceeds a speed limit of a road.

In various exemplary embodiments of the present invention, the recording of the front video, the rear video, and the rear-side video of the vehicle may include determining, by the controller, whether a rear-side vehicle located within a reference distance from the vehicle has entered a travel line of the vehicle based on the rear-side video, and determining, by the controller, that the dangerous situation has occurred to the vehicle when the controller determines that the rear-side vehicle has entered the travel line of the vehicle.

In various exemplary embodiments of the present invention, the recording of the front video, the rear video, and the rear-side video of the vehicle may include detecting, by the controller, a rear-side vehicle located within a reference distance from the vehicle based on the rear-side video, and determining, by the controller, that the dangerous situation has occurred to the vehicle when the controller determines that the rear-side vehicle is located within the reference distance from the vehicle while a turn signal lamp of the vehicle is turned on.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a device configured for recording a drive video of a vehicle according to various exemplary embodiments of the present invention;

FIG. 2A is an exemplary view showing a mounting location and a filming region of a camera provided in a device configured for recording a drive video of a vehicle according to various exemplary embodiments of the present invention;

FIG. 2B is another exemplary view showing a mounting location and a filming region of a camera provided in a device configured for recording a drive video of a vehicle according to various exemplary embodiments of the present invention;

FIG. 3A is a first exemplary view of a dangerous situation detected by a controller provided in a device configured for recording a drive video of a vehicle according to various exemplary embodiments of the present invention;

FIG. 3B is a second exemplary view of a dangerous situation detected by a controller provided in a device configured for recording a drive video of a vehicle according to various exemplary embodiments of the present invention;

FIG. 3C is a third exemplary view of a dangerous situation detected by a controller provided in a device configured for recording a drive video of a vehicle according to various exemplary embodiments of the present invention;

FIG. 3D is a fourth exemplary view of a dangerous situation detected by a controller provided in a device configured for recording a drive video of a vehicle according to various exemplary embodiments of the present invention;

FIG. 4 is a flowchart for a method for recording a drive video of a vehicle according to various exemplary embodiments of the present invention;

FIG. 5 is a flowchart for a method for recording a drive video of a vehicle according to various exemplary embodiments of the present invention;

FIG. 6 is a flowchart for a method for recording a drive video of a vehicle according to various exemplary embodiments of the present invention; and

FIG. 7 is a block diagram showing a computing system for executing a method for recording a drive video of a vehicle according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it may be noted that the identical or equivalent component is designated by the identical numeral even when they are displayed on other drawings. Furthermore, in describing the exemplary embodiment of the present invention, a detailed description of the related known configuration or function will be omitted when it is determined that it interferes with the understanding of the exemplary embodiment of the present invention.

In describing the components of the exemplary embodiment according to various exemplary embodiments of the present invention, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning which is consistent with their meaning in the context of the relevant art and will not be interpreted in an idealized or overly formal sense unless expressly so defined herein.

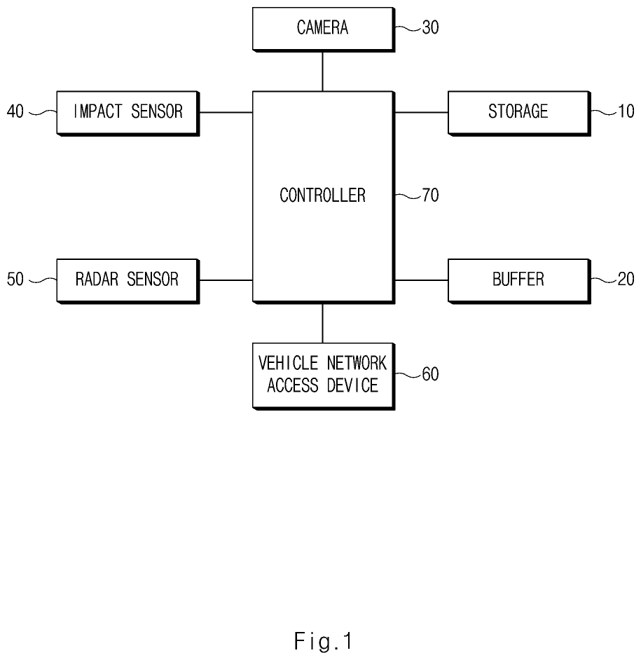

FIG. 1 is a block diagram of a device configured for recording a drive video of a vehicle according to various exemplary embodiments of the present invention.

As shown in FIG. 1, a device configured for recording a drive video of a vehicle according to various exemplary embodiments of the present invention may include storage 10, a buffer 20, a camera 30, an impact sensor 40, a radar sensor 50, a vehicle network access device 60, and a controller 70. In the present connection, depending on a scheme of implementing the device configured for recording the drive video of the vehicle according to various exemplary embodiments of the present invention, components may be combined with each other and implemented as one component, or some components may be omitted.

Each of the components will be described. First, the storage 10 may store various logics, algorithms, and programs required in a process of acquiring a rear-side video of the vehicle in association with a camera monitoring system (CMS), detecting a dangerous situation of the vehicle based on the acquired rear-side video, and recording the rear-side video of the vehicle as an event video in the detected dangerous situation.

In the present connection, the dangerous situation may include a case in which an amount of impact signal exceeding a reference value is received from the impact sensor 40, a case in which a travel speed of a rear-side vehicle exceeds a speed limit of a road, a case in which the rear-side vehicle located within a reference distance (e.g., 5 m) from a host vehicle 200 enters a travel line of the host vehicle 200, a case in which a first rear-side vehicle is located within the reference distance (e.g., 5 m) from the host vehicle 200 in a state in which a left-turn signal lamp is turned on, a case in which a second rear-side vehicle is located within the reference distance (e.g., 5 m) from the host vehicle 200 in a state in which a right-turn signal lamp is turned on, and the like.

The storage 10 may store a video filmed by the camera 30 as an event video or store a video stored in the buffer 20 as an event video under control of the controller 70.

Such storage 10 may include at least one type of recording media (storage media) of a memory of a flash memory type, a hard disk type, a micro type, a card type (e.g., a secure digital card (SD card) or an eXtream digital card (XD card)), and the like, and/or a memory of a random access memory (RAM), a static RAM (SRAM), a read-only memory (ROM), a programmable ROM (PROM), an electrically erasable PROM (EEPROM), a magnetic RAM (MRAM), a magnetic disk, and an optical disk type.

The buffer 20 is a high-speed storage device that temporarily stores the video filmed by the camera 30. When an impact is applied to the vehicle, a previous video based on an impact time point may be used as the event video.

The camera 30, which is a module mounted on the vehicle to film a video of a region around the vehicle, may include a front camera 31, a rear camera 32, a first rear-side camera 33, and a second rear-side camera 34.

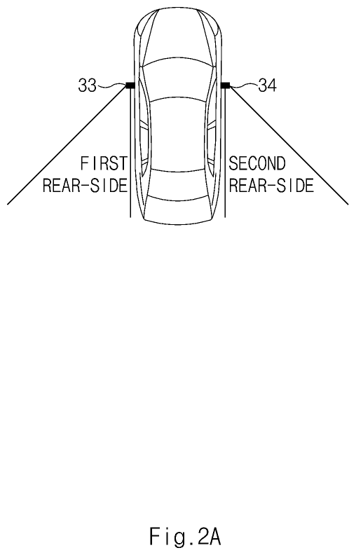

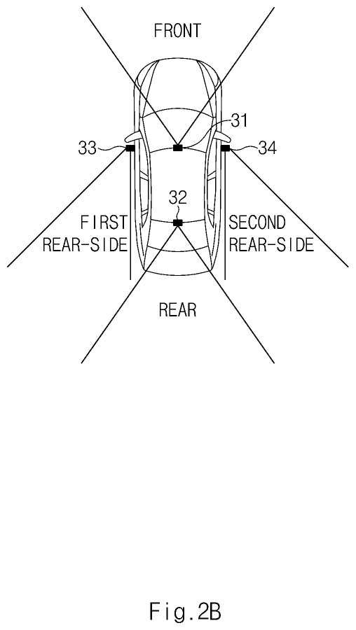

FIG. 2A is an exemplary view showing a mounting location and a filming region of a camera provided in a device configured for recording a drive video of a vehicle according to various exemplary embodiments of the present invention.

As shown in FIG. 2A, the camera 30 may be implemented with the first rear-side camera 33 and the second rear-side camera 34 provided in a camera monitoring system (CMS).

The first rear-side camera 33 is mounted at a left sideview mirror location of the vehicle to film a first rear-side video of the vehicle, and the second rear-side camera 34 is mounted at a right sideview mirror location of the vehicle to film a second rear-side video of the vehicle.

For reference, the CMS, which is a system that replaces a left sideview mirror of the vehicle, may have the first rear-side camera 33 instead of the left sideview mirror, may have the second rear-side camera 34 instead of a right sideview mirror, may have a left display device that displays a video filmed by the first rear-side camera 33 on a left side of an interior of the vehicle, and may have a right display device that displays a video filmed by the second rear-side camera 34 on a right side of the interior of the vehicle. Because such CMS provides the rear-side video of the vehicle without a blind spot, the CMS may not only prevent a risk of an accident when changing a line, but also solve a disadvantage that it is difficult for a driver to secure a rear-side view because of rainwater on a door window in case of rain.

FIG. 2B is another exemplary view showing a mounting location and a filming region of a camera provided in a device configured for recording a drive video of a vehicle according to various exemplary embodiments of the present invention.

As shown in FIG. 2B, the camera 30 may be implemented with the front camera 31, the rear camera 32, the first rear-side camera 33, and the second rear-side camera 34 provided in a surround view monitoring (SVM) system.

The front camera 31 is mounted on a rear surface of a rearview mirror mounted inside the vehicle to film a front video of the vehicle, the rear camera 32 is mounted on the interior or a rear portion of an exterior of the vehicle to film the rear video of the vehicle, the first rear-side camera 33 is mounted at the left sideview mirror location of the vehicle to film the first rear-side video of the vehicle, and the second rear-side camera 34 is mounted at the right sideview mirror location of the vehicle to film the second rear-side video of the vehicle.

The impact sensor 40 may measure not only whether the impact has been applied to the vehicle, but also an amount of impact applied to the vehicle. Such impact sensor 40 may be implemented as an acceleration sensor or a gyroscope sensor, but may not be necessarily limited thereto.

The radar sensor 50 may be mounted in a rear-side portion of the vehicle to detect a vehicle (the rear-side vehicle) located in a region rearwardly and laterally located from the vehicle and measure a separation distance from the rear-side vehicle.

The vehicle network access device 60, which is a module that provides an interface for accessing a vehicle network, may collect, from the vehicle network, speed information, start information (whether an engine is operating in a case of an internal combustion engine vehicle, and whether it is ready for departure in a case of an electric vehicle), and the like of the vehicle. In the present connection, the vehicle network may include a controller area network (CAN), a controller area network with flexible data-rate (CAN FD), a local interconnect network (LIN), a FlexRay, a media oriented systems transport (MOST), an Ethernet, and the like.

The controller 70 may perform overall control such that each of the components may perform a function thereof normally. Such controller 70 may be implemented in a form of hardware, may be implemented in a form of software, or may be implemented in a form of a combination of the hardware and the software. The controller 70 may be implemented as a microprocessor, but may not be limited thereto.

The controller 70 may perform various control required in a process of acquiring the front video, the rear video, and the rear-side video of the vehicle filmed by the camera 30, detecting the dangerous situation of the vehicle based on the acquired rear-side video, and recording, in the storage 10, the front video, the rear video, and the rear-side video of the vehicle as the event video in the detected dangerous situation.

The controller 70 may detect, as the dangerous situation, the case in which the amount of impact signal exceeding the reference value is received from the impact sensor 40, the case in which the travel speed of the rear-side vehicle exceeds the speed limit of the road, the case in which the rear-side vehicle located within the reference distance from the host vehicle 200 enters the travel line of the host vehicle 200, the case in which the first rear-side vehicle is located within the reference distance from the host vehicle 200 in the state in which the left-turn signal lamp is turned on, the case in which the second rear-side vehicle is located within the reference distance from the host vehicle 200 in the state in which a right-turn signal lamp is turned on, and the like.

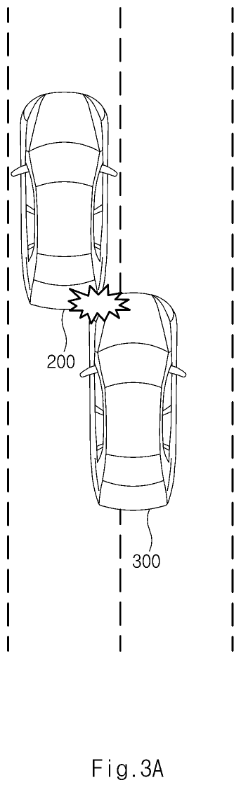

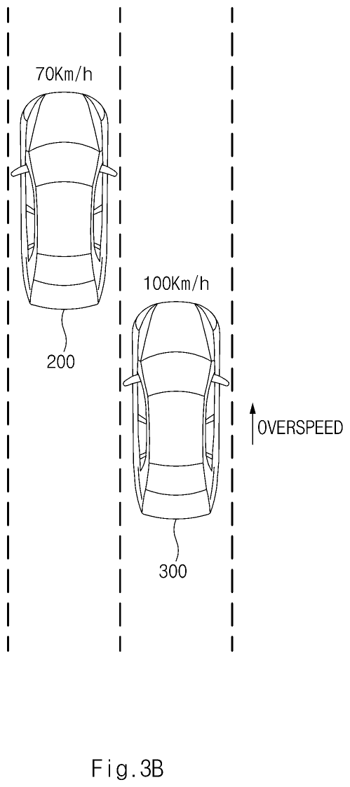

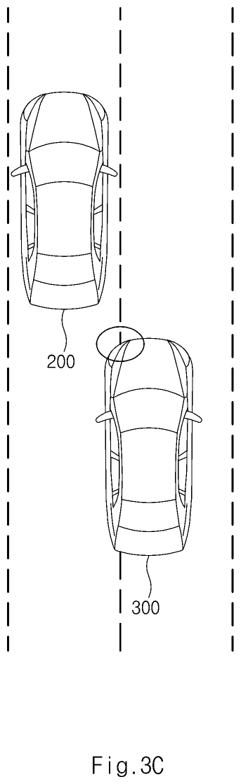

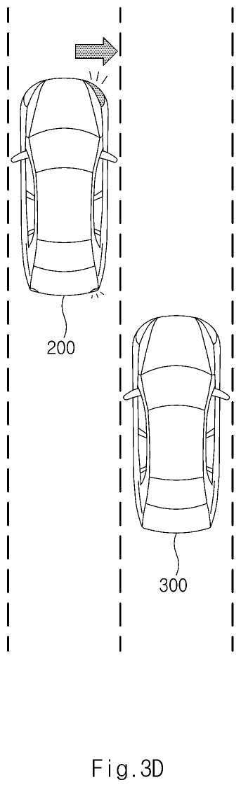

Hereinafter, an operation of the controller 70 will be described in detail with reference to FIG. 3A, FIG. 3B, FIG. 3C, and FIG. 3D.

FIG. 3A is a first exemplary view of a dangerous situation detected by a controller provided in a device configured for recording a drive video of a vehicle according to various exemplary embodiments of the present invention.

As shown in FIG. 3A, the controller 70 provided in the device configured for recording the drive video of the vehicle according to various exemplary embodiments of the present invention may determine that the dangerous situation has occurred to the host vehicle 200 when a rear-side vehicle 300 impacts the host vehicle 200, that is, when the amount of impact from the impact sensor 40 exceeds the reference value. In the present connection, the controller 70 may store, in the storage 10 as the event video, a drive video before an impact time point from the drive video (the front video, the rear video, and the rear-side video of the vehicle) stored in the buffer 20. In the present connection, the drive video may include at least one of the front video, the rear video, the first rear-side video (a left rear-side video), and the second rear-side video (a right rear-side video) of the vehicle.

In one example, the controller 70 may store the event video in the storage 10 even in a state in which the host vehicle 200 is parked. That is, when the amount of impact from the impact sensor 40 exceeds the reference value in the state in which the host vehicle 200 is parked (start-off), the controller 70 may store, in the storage 10 as the event video, a parking video before the impact time point from a parking video (the front video, the rear video, and the rear-side video of the vehicle) stored in the buffer 20. This is an example applied when the controller 70 activates the camera 30 even when the host vehicle 200 is parked. As various exemplary embodiments of the present invention, when the controller 70 deactivates the camera 30 in the state in which the host vehicle 200 is parked, the controller 70 may activate the camera 30 when the amount of impact from the impact sensor 40 exceeds the reference value, and store a parking video filmed by the camera 30 in the storage 10 as the event video. In the present connection, the parking video stored in the storage 10 as the event video includes all of the front video, the rear video, the first rear-side video, and the second rear-side video. However, because an impact that occurs in the parked state is usually caused by contact while a door of a vehicle next to the host vehicle 200 is opened, only the first rear-side video and the second rear-side video may be stored in the storage 10 as the event video.

FIG. 3B is a second exemplary view of a dangerous situation detected by a controller provided in a device configured for recording a drive video of a vehicle according to various exemplary embodiments of the present invention.

As shown in FIG. 3B, the controller 70 provided in the device configured for recording the drive video of the vehicle according to various exemplary embodiments of the present invention may determine that the dangerous situation has occurred to the host vehicle 200 in a case in which a speed of the rear-side vehicle 300 located within the reference distance (e.g., 5 m) from the host vehicle 200 exceeds the limit speed of the road, in a case in which the speed of the rear-side vehicle 300 is higher than a speed of the host vehicle 200 by a threshold (e.g., 30 km/h) or more, and in a case in which the speed of the rear-side vehicle 300 is higher than the limit speed of the road by a threshold (e.g., 20 km/h) or more. In the present connection, the controller 70 may store a drive video filmed by the camera 30 in the storage 10. In the present connection, the controller 70 may store the speed of the host vehicle 200 and the speed of the rear-side vehicle 300 together with the drive video filmed by the camera 30.

In one example, the controller 70 may estimate the speed of the rear-side vehicle 300 based on the speed of the host vehicle 200 collected from the vehicle network and the first rear-side video filmed by the first rear-side camera 33, or the speed of the host vehicle 200 collected from the vehicle network and the second rear-side video filmed by the second rear-side camera 34. That is, the controller 70 may detect the host vehicle 200 and the rear-side vehicle 300 as objects in the first rear-side video or in the second rear-side video, detect a relative speed based on a change in a separation distance for each time between the host vehicle 200 and the rear-side vehicle 300, and estimate the speed of the rear-side vehicle 300 based on the detected relative speed and the collected speed of the host vehicle 200.

FIG. 3C is a third exemplary view of a dangerous situation detected by a controller provided in a device configured for recording a drive video of a vehicle according to various exemplary embodiments of the present invention.

As shown in FIG. 3C, the controller 70 provided in the device configured for recording the drive video of the vehicle according to various exemplary embodiments of the present invention may determine that the dangerous situation has occurred to the host vehicle 200 in a case in which the rear-side vehicle 300 located within the reference distance (e.g., 5 m) from the host vehicle 200 enters the travel line of the host vehicle 200, and in a case in which the host vehicle 200 enters a travel line of the rear-side vehicle 300 in the state in which the rear-side vehicle 300 is located within the reference distance (e.g., 5 m) from the host vehicle 200. In the present connection, the controller 70 may store the drive video filmed by the camera 30 in the storage 10.

In one example, the controller 70 may detect the case in which the rear-side vehicle 300 located within the reference distance from the host vehicle 200 enters the travel line of the host vehicle 200 based on the first rear-side video filmed by the first rear-side camera 33 or the second rear-side video filmed by the second rear-side camera 34.

FIG. 3D is a fourth exemplary view of a dangerous situation detected by a controller provided in a device configured for recording a drive video of a vehicle according to various exemplary embodiments of the present invention.

As shown in FIG. 3D, the controller 70 provided in the device configured for recording the drive video of the vehicle according to various exemplary embodiments of the present invention may determine that the dangerous situation has occurred to the host vehicle 200 in the case in which the first rear-side vehicle is located within the reference distance from the host vehicle 200 in the state in which the left-turn signal lamp is turned on and in the case in which the second rear-side vehicle is located within the reference distance from the host vehicle 200 in the state in which the right-turn signal lamp is turned on. In the present connection, the controller 70 may store the drive video filmed by the camera 30 in the storage 10.

In one example, the controller 70 may detect the first rear-side vehicle located within the reference distance from the host vehicle 200 based on the first rear-side video filmed by the first rear-side camera 33, or may detect the second rear-side vehicle located within the reference distance from the host vehicle 200 based on the second rear-side video filmed by the second rear-side camera 34. In the present connection, the controller 70 may detect the first rear-side vehicle or the second rear-side vehicle located within the reference distance from the host vehicle 200 based on the radar sensor 50 provided in the host vehicle 200.

Furthermore, the controller 70 may detect the first rear-side vehicle or the second rear-side vehicle located within the reference distance from the host vehicle 200 based on a warning signal from a blind spot detection (BSD) system provided in the host vehicle 200.

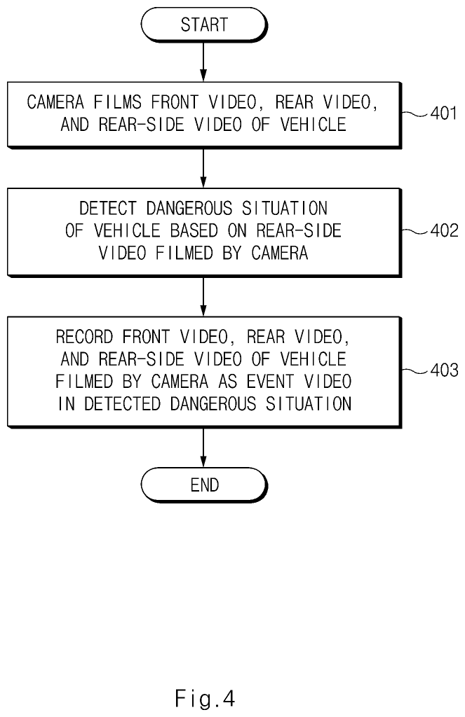

FIG. 4 is a flowchart for a method for recording a drive video of a vehicle according to various exemplary embodiments of the present invention.

First, the camera 30 films the front video, the rear video, and the rear-side video of the vehicle (401).

Thereafter, the controller 70 detects the dangerous situation of the vehicle based on the rear-side video filmed by the camera 30 (402).

Thereafter, the controller 70 records the front video, the rear video, and the rear-side video of the vehicle filmed by the camera 30 as the event video in the detected dangerous situation (403). In the present connection, the controller 70 may detect, as the dangerous situation, the case in which the amount of impact signal exceeding the reference value is received from the impact sensor 40, the case in which the travel speed of the rear-side vehicle exceeds the speed limit of the road, the case in which the rear-side vehicle located within the reference distance from the host vehicle 200 enters the travel line of the host vehicle 200, the case in which the first rear-side vehicle is located within the reference distance from the host vehicle 200 in the state in which the left-turn signal lamp is turned on, the case in which the second rear-side vehicle is located within the reference distance from the host vehicle 200 in the state in which a right-turn signal lamp is turned on, and the like.

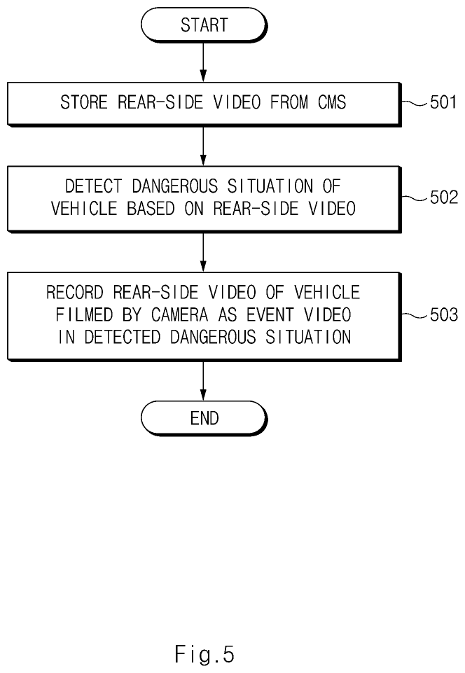

FIG. 5 is a flowchart for a method for recording a drive video of a vehicle according to various exemplary embodiments of the present invention.

First, the buffer 20 stores the rear-side video from the CMS (501).

Thereafter, the controller 70 detects the dangerous situation of the vehicle based on the rear-side video stored in the buffer 20 (502).

Thereafter, the controller 70 records the rear-side video of the vehicle filmed by the camera 30 as the event video in the detected dangerous situation (503).

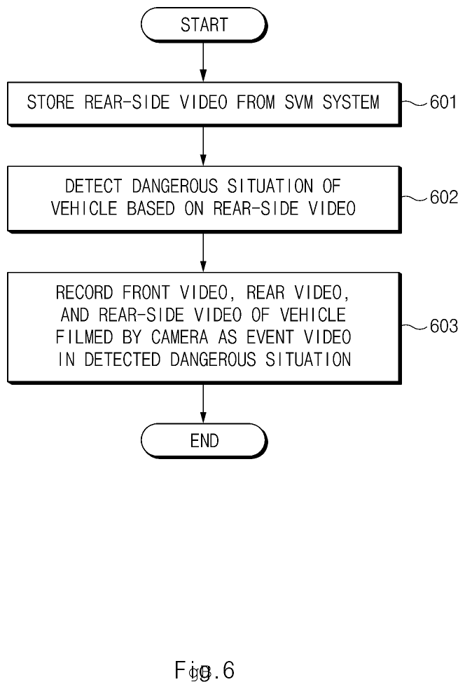

FIG. 6 is a flowchart for a method for recording a drive video of a vehicle according to various exemplary embodiments of the present invention.

First, the buffer 20 stores the rear-side video from the SVM system (601).

Thereafter, the controller 70 detects the dangerous situation of the vehicle based on the rear-side video stored in the buffer 20 (602).

Thereafter, the controller 70 records the front video, the rear video, and the rear-side video of the vehicle filmed by the camera 30 as the event video in the detected dangerous situation (603).

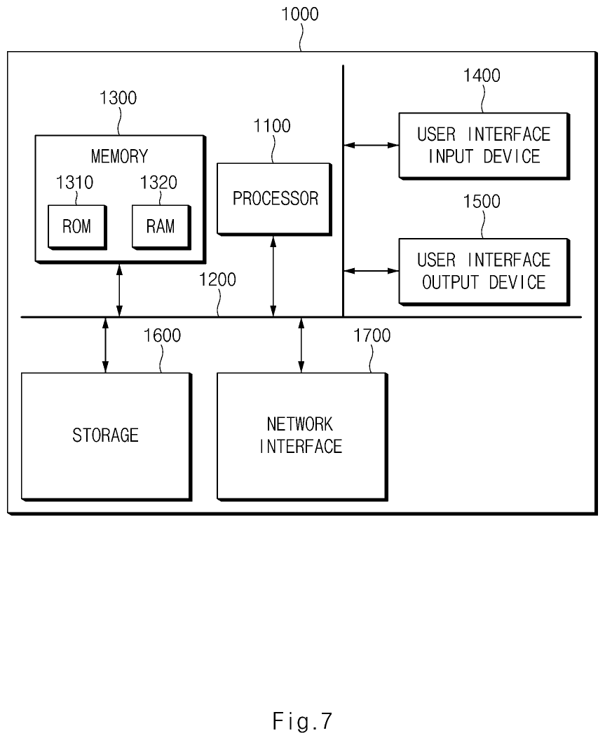

FIG. 7 is a block diagram showing a computing system for executing a method for recording a drive video of a vehicle according to various exemplary embodiments of the present invention.

Referring to FIG. 7, the method for recording the drive video of the vehicle according to various exemplary embodiments of the present invention described above may also be implemented through a computing system. A computing system 1000 may include at least one processor 1100, a memory 1300, a user interface input device 1400, a user interface output device 1500, storage 1600, and a network interface 1700 connected via a system bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present invention, and various modifications and changes may be made by those skilled in the art without departing from the essential characteristics of the present invention.

Therefore, the exemplary embodiments included in various exemplary embodiments of the present invention are not intended to limit the technical idea of the present invention but to illustrate the present invention, and the scope of the technical idea of the present invention is not limited by the embodiments. The scope of the present invention may be construed as being covered by the scope of the appended claims, and all technical ideas falling within the scope of the claims may be construed as being included in the scope of the present invention.

The device and the method for recording the drive video of the vehicle according to various exemplary embodiments of the present invention as described above may acquire the rear-side video of the vehicle in association with the camera monitoring system (CMS), detect the dangerous situation of the vehicle based on the acquired rear-side video, and record the rear-side video of the vehicle as the event video in the detected dangerous situation, providing the user with the rear-side video which may prove the fault of the rear-side vehicle caused the dangerous situation.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A device for recording a drive video of a vehicle, the device comprising:
a camera configured for filming a front video, a rear video, and a rear-side video of the vehicle; and
a controller electrically connected to the camera and configured to:
detect a dangerous situation of the vehicle according to the rear-side video; and
record the front video, the rear video, and the rear-side video of the vehicle as an event video in a storage electrically connected to the controller, in the dangerous situation.

2. The device of claim 1, further including:
a buffer electrically connected to the controller and configured for storing the front video, the rear video, and the rear-side video of the vehicle filmed by the camera, for a predetermined time period; and
a sensor electrically connected to the controller and configured for detecting an amount of impact applied to the vehicle.

3. The device of claim 2, wherein the controller is configured to determine that the dangerous situation has occurred to the vehicle, and record, in the storage as the event video, a video before an impact time point from the front video, the rear video, and the rear-side video of the vehicle stored in the buffer when the controller determines that the amount of the impact detected by the sensor exceeds a reference value.

4. The device of claim 2, wherein the controller is configured to:
activate the camera and the sensor while the vehicle is being parked; and
determine that the dangerous situation has occurred to the vehicle, and record, in the storage as the event video, a video before an impact time point from the front video, the rear video, and the rear-side video of the vehicle stored in the buffer when the controller determines that the amount of the impact detected by the sensor exceeds a reference value.

5. The device of claim 2, wherein the controller is configured to:
activate the sensor while the vehicle is being parked; and
determine that the dangerous situation has occurred to the vehicle to activate the camera, and record the front video, the rear video, and the rear-side video of the vehicle filmed by the camera, in the storage as the event video when the controller determines that the amount of the impact detected by the sensor exceeds a reference value.

6. The device of claim 2, wherein the controller is configured to:
activate the sensor while the vehicle is being parked; and
determine that the dangerous situation has occurred to the vehicle to activate the camera, and record the rear-side video of the vehicle filmed by the camera, in the storage as the event video when the controller determines that the amount of the impact detected by the sensor exceeds a reference value.

7. The device of claim 1, wherein the controller is configured to determine that the dangerous situation has occurred to the vehicle, and record the front video, the rear video, and the rear-side video of the vehicle filmed by the camera, in the storage as the event video when the controller determines that a speed of a rear-side vehicle located within a reference distance from the vehicle exceeds a speed limit of a road.

8. The device of claim 7, wherein the controller is configured to:
estimate the speed of the rear-side vehicle according to a speed of the vehicle and the rear-side video; and
record the speed of the vehicle and the speed of the rear-side vehicle together with the event video.

9. The device of claim 1, wherein the controller is configured to determine that the dangerous situation has occurred to the vehicle, and record the front video, the rear video, and the rear-side video of the vehicle filmed by the camera, in the storage as the event video when the controller determines that a rear-side vehicle located within a reference distance from the vehicle enters a travel line of the vehicle.

10. The device of claim 9, wherein the controller is configured to determine whether the rear-side vehicle has entered the travel line of the vehicle according to the rear-side video.

11. The device of claim 1, wherein the controller is configured to determine that the dangerous situation has occurred to the vehicle, and record the front video, the rear video, and the rear-side video of the vehicle filmed by the camera, in the storage as the event video when the controller determines that a rear-side vehicle is located within a reference distance from the vehicle while a turn signal lamp of the vehicle is turned on.

12. The device of claim 11, wherein the controller is configured to detect the rear-side vehicle located within the reference distance from the vehicle according to the rear-side video.

13. A method for recording a drive video of a vehicle, the method comprising:
filming, by a camera, a front video, a rear video, and a rear-side video of the vehicle; and
detecting, by a controller electrically connected to the camera, a dangerous situation of the vehicle according to the rear-side video, and recording the front video, the rear video, and the rear-side video of the vehicle as an event video in a storage electrically connected to the controller, in the dangerous situation.

14. The method of claim 13, wherein the recording of the front video, the rear video, and the rear-side video of the vehicle includes:
storing, by a buffer electrically connected to the controller, the front video, the rear video, and the rear-side video of the vehicle filmed by the camera, for a predetermined time period;
detecting, by a sensor electrically connected to the controller, an amount of impact applied to the vehicle; and
determining, by the controller, that the dangerous situation has occurred to the vehicle, and recording, in the storage as the event video, a video before an impact time point from the front video, the rear video, and the rear-side video of the vehicle stored in the buffer when the controller determines that the amount of impact exceeds a reference value.

15. The method of claim 13, wherein the recording of the front video, the rear video, and the rear-side video of the vehicle includes:
storing, by a buffer electrically connected to the controller, the front video, the rear video, and the rear-side video of the vehicle filmed by the camera, for a predetermined time period;
activating, by the controller, the camera and a sensor electrically connected to the controller and configured for detecting an amount of impact applied to the vehicle while the vehicle is being parked; and
determining, by the controller, that the dangerous situation has occurred to the vehicle, and recording, in the storage as the event video, a video before an impact time point from the front video, the rear video, and the rear-side video of the vehicle stored in the buffer when the controller determines that the amount of impact exceeds a reference value.

16. The method of claim 13, wherein the recording of the front video, the rear video, and the rear-side video of the vehicle includes:
activating, by the controller, a sensor electrically connected to the controller and configured for detecting an amount of impact applied to the vehicle while the vehicle is being parked; and
determining that the dangerous situation has occurred to the vehicle to activate the camera, and recording the front video, the rear video, and the rear-side video of the vehicle filmed by the camera, in the storage as the event video when the controller determines that the amount of impact exceeds a reference value.

17. The method of claim 13, wherein the recording of the front video, the rear video, and the rear-side video of the vehicle includes:
activating, by the controller, a sensor electrically connected to the controller and configured for detecting an amount of impact applied to the vehicle while the vehicle is being parked; and
determining, by the controller, that the dangerous situation has occurred to the vehicle to activate the camera, and recording the rear-side video of the vehicle filmed by the camera, in the storage as the event video when the controller determines that the amount of impact exceeds a reference value.

18. The method of claim 13, wherein the recording of the front video, the rear video, and the rear-side video of the vehicle includes:
estimating, by the controller, a speed of a rear-side vehicle located within a reference distance from the vehicle according to the rear-side video and a speed of the vehicle; and
determining, by the controller, that the dangerous situation has occurred to the vehicle, and recording the speed of the vehicle and the speed of the rear-side vehicle together with the event video when the controller determines that the speed of the rear-side vehicle exceeds a speed limit of a road.

19. The method of claim 13, wherein the recording of the front video, the rear video, and the rear-side video of the vehicle includes:
determining, by the controller, whether a rear-side vehicle located within a reference distance from the vehicle has entered a travel line of the vehicle according to the rear-side video; and
determining, by the controller, that the dangerous situation has occurred to the vehicle when the controller determines that the rear-side vehicle has entered the travel line of the vehicle.

20. The method of claim 13, wherein the recording of the front video, the rear video, and the rear-side video of the vehicle includes:
detecting, by the controller, a rear-side vehicle located within a reference distance from the vehicle according to the rear-side video; and
determining, by the controller, that the dangerous situation has occurred to the vehicle when the controller determines that the rear-side vehicle is located within the reference distance from the vehicle while a turn signal lamp of the vehicle is turned on.
